(19) United States
(12) Patent Application Publication
(10) Pub. No.: US 2007/0022594 A1
(43) Pub. Date: Feb. 1, 2007

(54) Device and method for releasing a rivet connection

(75) Inventors: Werner Hakenjos, Villingen-Schwenningen (DE); Martin Strasser, Bad Duerrheim (DE)

Correspondence Address: Charles N. J. Ruggiero;Ohlandt, Greeley, Ruggiero & Perle, L.L.P., 10th Floor, One Landmark Square, Stamford, CT, 06901-2682, US

(73) Assignee: MV Marketing und Vertriebs-GmbH & Co. KG Wielander + Schill

(21) Appl. No.: 11/477,224

(22) Filed: Jun. 29, 2006

(30) Foreign Application Priority Data
Jun. 30, 2005 (DE) 10 2005 030 979.8
Feb. 10, 2005 (DE) 10 2006 006 440.2

(51) Int. Cl. B23P 19/02

(52) U.S. Cl. 29/426.4

(57) ABSTRACT

A device is proposed for releasing a rivet connection, in particular a press-in nut, which device comprises a pin which can be screwed into a thread which secures a threaded pin. The head of the rivet can be milled away by means of a milling cutter running around the threaded pin. The invention prevents a remaining threaded stem from dropping into a cavity of the bodywork.

### CROSS-REFERENCE TO RELATED APPLICATIONS

This application claims the benefit under 35 U.S.C. §119(a) of German Application Serial No. 10 2005 030 979.8 filed Jun. 30, 2005 and German Application Serial No. 10 2006 006 440.2 filed Feb. 10, 2006, the entire contents of both of which are incorporated by reference herein.

### BACKGROUND OF THE INVENTION

1. Field of the Invention

The invention relates to a device and a method for releasing a rivet connection, in particular a hollow rivet connection or press-in nut. In particular, a tool for drilling out nuts inserted by riveting is the subject matter of the invention.

2. Description of Related Art

In order to remove rivets, use is generally made in practice of a separating grinder or the rivets are removed with a hammer and chisel.

By contrast, DE 600 05 891 shows a method in which a rivet is milled away with a milling cutter.

When milling away a rivet by means of a rotating milling cutter, it is problematic that the centering of the milling cutter is difficult. The milling cutter thus generally tends to slide off, which may lead to the surrounding material being damaged.

In addition, in particular in the case of components in which the rivet connection is only accessible from one side, it is problematic that remains of the rivet drop down during the milling-away operation. In particular in the case of vehicles, it is extremely undesirable that, for example, the lower part of a rivet drops into a cavity of the bodywork where it may then result in noises and damage. In addition to noises, the rivet remains may also result in contact corrosion. Damage to existing cavity seals by means of rivet remains may also result in further corrosion damage.

### BRIEF SUMMARY OF THE INVENTION

By contrast, the invention is based on the object of providing a device and a method for releasing a rivet connection, in which the rivet can be easily removed and the tool is prevented as far as possible from running away.

In addition, it is the object of the invention to prevent the lower part of a rivet from dropping down after the upper part is removed and thus being able, for example, to drop into a cavity of the bodywork.

The object of the invention is already achieved by a device for releasing a rivet connection and by a method for removing a rivet nut.

According to the invention, a device is provided for releasing a rivet connection, in particular a hollow rivet connection or a press-in nut, which device comprises a material-removing tool which is arranged rotatably about a pin in order to remove a rivet head.

Material-removing tool within the context of the application is understood as meaning, for example, a drill or a milling cutter which rotates about a centrally arranged pin. It can be either an axially symmetrical tool, in the axis of rotation of which the pin is arranged, or else an individual cutting lip running about a pin, or a plurality of cutting lips which are not axially symmetrical are provided, according to the invention, as possible embodiments. The pin can be inserted by a lower end into a hole or a thread of a rivet. According to the invention, the removal of rivet nuts or rivets which have at least one cutout is therefore provided in particular.

However, the invention is suitable in principle also for removing rivets in general if the latter are provided in advance with a hole for the insertion of the pin.

The effect achieved by the pin is that the material-removing tool is optimally centered. Damage to the surrounding metal sheet is thus prevented. In addition, given suitable shaping of the lower end, the pin serves in order to secure the lower part of the rivet, which is not milled away.

In a preferred embodiment of the invention, the pin has, at the lower end, a thread for screwing into a rivet, in particular into a press-in nut. The device for releasing a rivet connection can thus be first of all screwed into a rivet nut. With the rotating tool, the upper part of the rivet nut, also referred to as rivet head, is then milled away. The remaining residual rivet sticks to the pin and can be pulled out without there being the risk of parts of it dropping into a cavity of the bodywork.

As an alternative to the thread, it is conceivable to use, as holding device for a remaining rivet residue, a hook or a clamping device by means of which a remaining rivet residue can likewise be secured.

In a further preferred embodiment of the invention, the material-removing tool is designed as a castellated milling cutter. It is an essentially axially symmetrical tool. The castellated milling cutter has an essentially axially symmetrical hole in the center, in which the pin is arranged in order to center and secure rivet residues. A castellated milling cutter of this type permits a cutting removal of material. In comparison to the geometry of a metal drill, the geometry of a castellated milling cutter has the advantage that the edges, which are present as a consequence of the central hole, on the inside of the tool have less tendency to break off.

In a development of the invention, the material-removing tool comprises a holding arbor to which the tool head, in particular the castellated milling cutter, can be fastened. The material-removing tool is thus of at least two-part design. The castellated milling cutter can easily be exchanged and replaced for another one, in particular if it is worn or in order to use a different milling-cutting diameter. The holding arbor can serve to clamp the tool in a drilling machine or else, according to the invention, bearings are provided in the holding arbor in order to mount the material-removing tool rotatably with respect to the pin.

The holding arbor preferably has a thread to which the castellated milling cutter can be tightly screwed. In a development of the invention, the pin can be temporarily locked against the material-removing tool. This has the advantage that the pin can be locked in a first machining step. The pin thus rotates only if the material-removing tool is clamped in the drilling machine. When the pin is locked in place, the thread at the lower end of the pin can then be screwed into a rivet nut. In a second machining step, the locking can be released and the upper part of the rivet can be milled away by means of the milling cutter.

In a preferred manner, the locking takes place via a locking nut at the upper end of the device. The pin then extends from the lower end of the material-removing tool to the upper end and can be locked in place at the upper end.

In a development of the invention, the pin and the material-removing tool can be locked by means of a latching mechanism which can also be combined with a locking nut.

In a preferred manner, the latching mechanism is released after a certain torque. It is thus possible that the operator does not have to undertake any further operating procedures to the device in order to screw the pin in and for the milling-away operation. The device is introduced, for example into a thread, in a latched state. The thread is screwed in by means of a drilling machine. As soon as the thread of the pin has been completely screwed in, the pin is secured, and so the latching mechanism is released. Then, only the material-removing tool with which the upper part of the rivet is milled away rotates.

In order to release the latching after a certain torque, in a particular embodiment of the invention, a sliding clutch is provided.

In a development of the invention, a spring which, in the locked state, exerts an axial force is arranged between the material-removing tool and the pin. The material-removing tool and pin are therefore under tension. As soon as the locking is released, the milling cutter is released and moves forward in the axial direction.

In a further preferred embodiment of the invention, the material-removing tool is arranged rotatably with respect to the pin on at least one bearing. In a preferred embodiment, a bearing of this type comprises a bushing which can be integrated in particular in the holding arbor. The friction during the revolving of the material-removing tool, in particular of the castellated milling cutter, is thus substantially reduced.

In a development of the invention, the pin has a self-cutting thread at its lower end. It is thus also possible for rivets with a cutout and which do not have a thread, i.e. are not designed as rivet nuts, to be secured.

In a preferred embodiment of the invention, the pin and the material-removing tool are designed such that they can at least partially be moved freely axially with respect to each other.

For example, when screwed in, the pin can thus sit fixedly in a thread while the tool can be moved axially and can thus be caused to rotate in order to remove the rivet head.

In a development of the invention, the tool is secured against the pin at least in one direction axially against slipping out. In particular, it is provided that the tool is secured against slipping out on the side pointing to the rivet. It is thus prevented that the device for releasing a rivet connection can fall apart during use.

The material-removing tool can preferably be clamped into a drilling machine by means of the holding arbor. For this purpose, a clamping groove can be arranged on the holding arbor preventing the material-removing tool from sliding through during the milling cutting.

The pin preferably has a diameter of between 1.5 and 15 millimeters (mm). Various pin diameters for matching different rivets are provided. In order to remove the head or the upper part of a rivet, the diameter of the material-removing tool, i.e. in particular of the milling cutter, is 1.5 to 6 mm larger than the diameter of the pin. The tool can be matched to different rivets via different diameters of the milling cutter.

In a preferred embodiment of the invention, the holding arbor and pin are clamped in the axial direction by a spring. The holding arbor is thus guided neatly by the milling cutter, with the holding arbor and pin being secured by a securing pin or a securing ring against falling apart.

Via a groove in which securing pin or securing ring can be latched, a locking mechanism is implemented which at the same time forms an axial means of securing the pin and holding arbor.

So that the chips are preferably removed upward in order to avoid chips dropping into the hole, in a preferred embodiment of the invention the faces of the castellated milling cutter run, at least in some sections, at an angle of 0.1° to 30°, preferably of 0.5° to 15°, with respect to the axis of rotation of the castellated milling cutter.

The flutes preferably run rectilinearly, so that the castellated milling cutter also has a rake angle of 0.1° to 30°, preferably of 0.5° to 15°.

In a further preferred embodiment of the invention, the cutting edges of the castellated milling cutter are relief-ground into at least two steps. In this case, a first step preferably has a clearance angle of 5° to 30° and a second step has a clearance angle of 30° to 70°. This enables the tool to be highly stable at the tip while the recesses are at the same time of a sufficient size in order to remove chips to the outside.

The invention furthermore relates to a method for removing a rivet nut. In this case, a pin is screwed by a thread into the rivet nut. After the pin is screwed in, or even as it is being screwed in, the head of the rivet nut is milled away by means of a material-removing tool rotating about the threaded pin. The remaining threaded stem is secured by the pin and is pulled out by means of the pin. The rivet nut is preferably removed with a device according to the invention. The pin is preferably first of all locked against the material-removing tool and is released after the pin is screwed in. The pin is therefore designed in the front region as a threaded pin.

Besides being suitable for a rivet nut and press-in nut, the invention is in particular also suitable for all types of nuts fastened to a metal sheet, i.e., in addition to the rivet nuts, is also suitable for welding nuts, threaded-rivet flanging nuts, punch-in nuts, anchoring nuts, etc.

### BRIEF DESCRIPTION OF THE SEVERAL VIEWS OF THE DRAWINGS

The invention will be explained in more detail below with reference to the figures, FIG. 1 and FIG. 2.

FIG. 1 shows a diagrammatic illustration of a tool according to the invention for releasing a rivet connection,

FIG. 2 shows a diagrammatic view of a tool of this type in plan view,

FIG. 3 shows a further embodiment of a tool according to the invention for releasing a rivet connection, in a diagrammatic illustration,

FIG. 4 shows the tool according to FIG. 3 in a perspective illustration, in a partially dismantled state,

FIG. 5 shows the tool according to FIG. 3 in a perspective illustration,

FIG. 6 shows, diagrammatically, the castellated milling cutter of the tool from FIG. 3 in a detailed view.

### DETAILED DESCRIPTION OF THE INVENTION

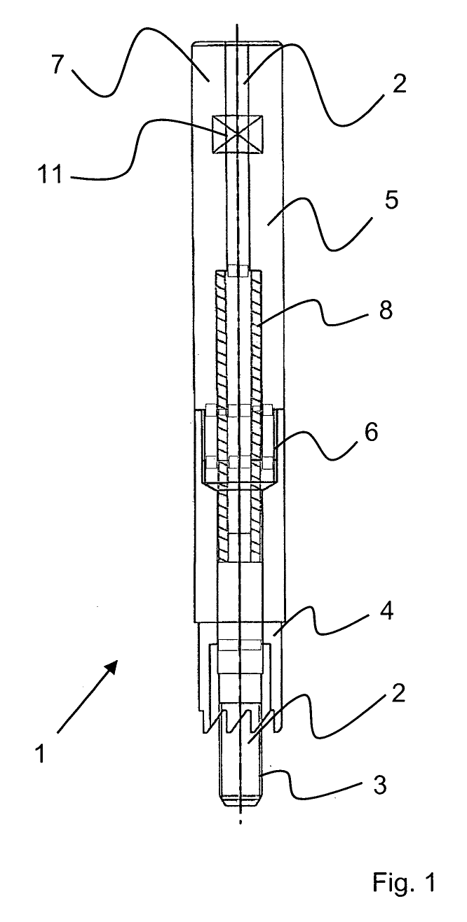

A device for releasing a rivet connection 1 can be seen diagrammatically in FIG. 1. The device for releasing a rivet connection 1 essentially comprises a pin 2 which, at the front end, has a thread 3 for screwing into a nut fastened to a metal sheet, in particular a press-in nut (not illustrated). Furthermore, the device for releasing a rivet connection 1 comprises a material-removing tool in the form of a castellated milling cutter 4 which is screwed onto a holding arbor 5 by means of a thread 6. The holding arbor has a clamping shank 7 which is situated at the upper end of the device. The device is clamped in a drilling machine by way of the clamping shank 7. Clamping shank 7 and castellated milling cutter 4 have a central hole through which the pin 2 extends. In principle, the pin 3 is arranged in a rotatable and axially displaceable manner in the clamping shank 7 and castellated milling cutter 4. To reduce the friction, the pin 2 is mounted in a bushing 8, as indicated diagrammatically by the hatching. Furthermore, the device for releasing a rivet connection 1 has a locking mechanism 11 which is not illustrated in detail in the drawing. The pin 2 and clamping shank 7 or castellated milling cutter 4 can be secured both against a rotational movement and against an axial movement via the locking mechanism. Thus, when the pin 2 is locked in place, the tool can be driven by means of a drilling machine (not illustrated) on the clamping shank 7. Since the pin 2 is locked in place, the thread 3 can thus be screwed into a rivet nut by means of the drilling machine. When the thread 3 is screwed into the rivet nut, the locking mechanism 11 is released. The castellated milling cutter 4 or holding arbor 5 can thus be moved freely, also in the axial direction. The castellated milling cutter 4 is now driven by means of the drill and rotates about the pin. The operator can then push the castellated milling cutter forward in the axial direction and mill away the head, for example, of a press-in nut (not illustrated). After the head of the press-in nut is milled away, the threaded pin (not illustrated) sticks to the thread 3 of the pin 2 and can be pulled out with the entire device. The dropping of a threaded pin into cavities of the bodywork is thus avoided.

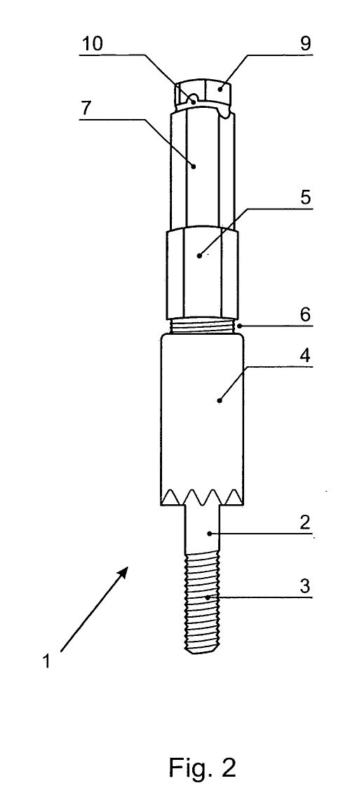

FIG. 2 shows a diagrammatic plan view of a device according to the invention for releasing a rivet connection 1. A pin 2 which has a thread 3 at its lower end can also be seen here. The device furthermore has a castellated milling cutter 4 which is fastened by means of a thread 6 to a holding arbor 5 with a clamping shank 7 for clamping into a drilling machine. At the upper end of the device for releasing a rivet connection 1 there is a locking nut 9 via which the castellated milling cutter 4 together with the holding arbor 5 can be secured against the pin 2 by means of a locking pin 10. As soon as the thread 3 has penetrated into a rivet nut, the locking is released. In addition, in the upper part of the device for releasing a rivet connection there is a spring (not illustrated) which, after the locking is released, displaces the holding arbor 5 downward in the axial direction toward the pin 2.

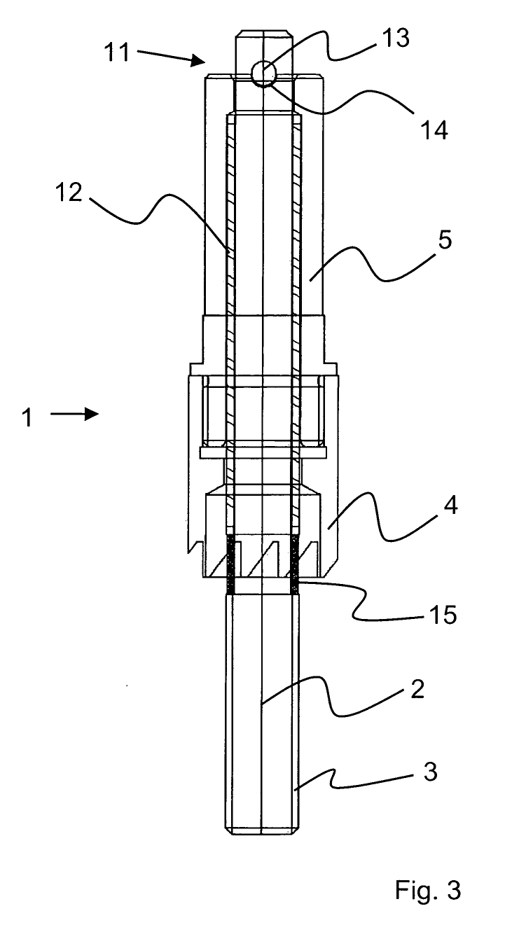

FIG. 3 shows a further embodiment of a tool according to the invention for releasing a rivet connection 1, in a diagrammatic illustration.

The tool is designed in particular for drilling out nuts inserted by riveting. For this purpose, it is screwed with a pin 2, which has a thread 3 at the front end, into the rivet nut to be removed. The tool can be clamped on the holding arbor 5 into a drilling machine (not illustrated) for this. The holding arbor 5 is screwed to a castellated milling cutter 4.

As an alternative, the holding arbor 5 and castellated milling cutter 4 may also be designed as an integral component (not illustrated).

Between the holding arbor 5 and pin 2 there is a spring 12, designed as a spiral spring, which keeps the holding arbor 5 together with the castellated milling cutter 4 under tension axially against the pin 2. For this purpose, a sleeve 15 on which the spring 12 bears is arranged on the pin 2 as the lower stop. The tensioned spring bears on its other side on the holding arbor 5 which is drilled open further in order to receive the spring 12 as far as this bearing surface.

The holding arbor 5 and pin 2 are secured against falling apart by a locking mechanism 11. The locking mechanism 11 comprises a securing pin 13 which has been pushed through a hole in the pin. The holding arbor 5 has an approximately corresponding groove 14 in which the securing pin 13 can latch.

When the tool is screwed in, the holding arbor 5 including the castellated milling cutter 4 are secured by the latching mechanism 11 against rotation. If the thread 3 is screwed in, the latching mechanism 11 slides through, so that the pin 2 can no longer rotate further.

The operator can now press down the tool, as a result of which the spring 12 is compressed and the castellated milling cutter 4 can reach the metal sheet.

After the rivet (not illustrated) is milled away, the rest of the rivet sticks to the thread 3 of the pin 2 and is not dropped into the hole.

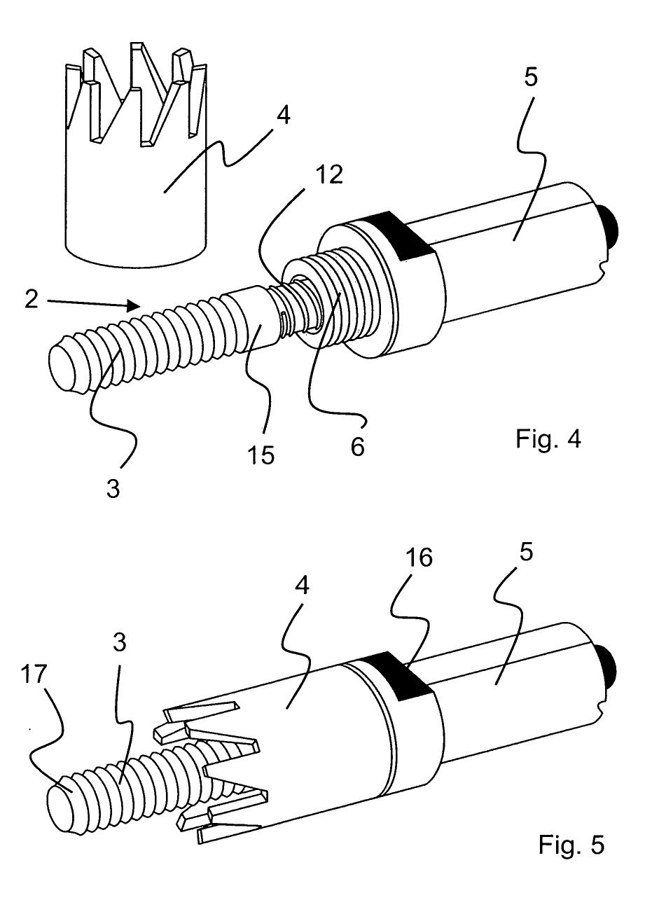

FIG. 4 shows the tool according to FIG. 3 in a perspective illustration and in a partially dismantled state. In this case, the castellated milling cutter 4 is unscrewed from the holding arbor 5. The thread 6 of the holding arbor 5 for the screwing-on of the castellated milling cutter 4 can be seen.

The front region of the spring 12 arranged in the axial direction between the holding arbor 5 and pin 2 can likewise be seen. At its front end, the spring 12 bears against a sleeve 15 which is pushed onto the pin 2. Within the context of the invention, the sleeve 15 and pin 2 may also form one component. The sleeve 15 ensures a more reliable means of securing in comparison to a spring 12 which bears directly on the thread 3.

FIG. 5 shows the tool according to FIG. 3 in a perspective illustration, to be precise in the assembled state. The holding arbor 5 and castellated milling cutter 4 are assembled. For better dismantling and assembling of the tool, the holding arbor 5, which is otherwise of essentially circular-cylindrical design, has key faces 16 on which, in particular, a fork wrench can be fitted.

For easier screwing-in, the thread 3 is provided at the front with a beveled edge 17.

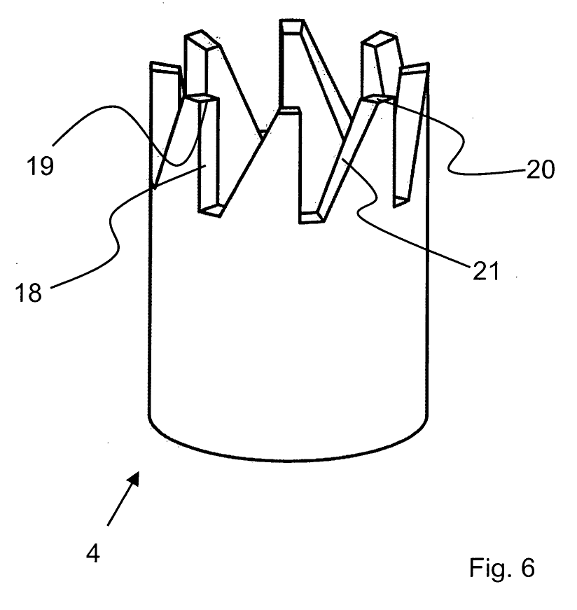

FIG. 6 shows, diagrammatically, the castellated milling cutter of the tool from FIG. 3 in a detailed view. The cutting faces 3 of the castellated milling cutter are slightly beveled, so that they have a positive rake angle of between 0.5° and 5°. Even such a small rake angle is sufficient for the chips to be removed essentially upward, i.e. in the direction of the holding arbor (5 from FIG. 3).

In order to reduce the friction, the cutting edges 19 of the castellated milling cutter 4 are relief-ground. The ground relief comprises a first step 20 with a clearance angle of 5° to 25°. The first step 20 is adjoined by a second step 21 with a clearance angle of 35° to 55°.

The small clearance angle directly behind the cutting edges 19 prevents the cutting edges 19 from rapidly breaking off. The clearance angle, which increases in profile, permits a large area of the casing of the milling cutter to be grasped by the recesses formed by the clearance angle, which improves the removal of chips.

The castellated milling cutter has between four and sixteen cutting lips. The exemplary embodiment illustrated has eight cutting lips.

### LIST OF REFERENCE NUMBERS

1 Device for releasing a rivet connection

2 Pin

3 Thread

4 Castellated milling cutter

5 Holding arbor

6 Thread

7 Clamping shank

8 Bushing

9 Locking nut

10 Locking pin

11 Locking mechanism

12 Spring

13 Securing pin

14 Groove

15 Sleeve

16 Key face

17 Beveled edge

18 Face

19 Cutting edge

20 First step

21 Second step

1. A device for releasing a rivet connection having a rivet head and a hollow rivet, the device comprising:
at least one material-removing tool that is arranged rotatably about a pin in order to remove the rivet head, the pin having a lower end that is insertable into the hollow rivet.

2. The device for releasing a rivet connection as claimed in claim 1, wherein the pin has a thread for screwing into the hollow rivet.

3. The device for releasing a rivet connection as claimed in claim 1, wherein the at least one material-removing tool comprises a castellated milling cutter.

4. The device for releasing a rivet connection as claimed in claim 3, wherein the at least one material-removing tool comprises a holding arbor to which the castellated milling cutter can be fastened.

5. The device for releasing a rivet connection as claimed in claim 4, wherein the castellated milling cutter is screwed on the holding arbor.

6. The device for releasing a rivet connection as claimed in claim 1, wherein the pin can be locked against the at least one material-removing tool.

7. The device for releasing a rivet connection as claimed in claim 6, wherein the pin has a locking nut approximately at an upper end.

8. The device for releasing a rivet connection as claimed in claim 1, wherein the pin and the at least one material-removing tool can be locked by a latching mechanism.

9. The device for releasing a rivet connection as claimed in claim 8, wherein the latching mechanism is released after a predetermined torque.

10. The device for releasing a rivet connection as claimed in claim 1, further comprising a spring arranged between the at least one material-removing tool and the pin, the spring exerting an axial force at least in a locked state.

11. The device for releasing a rivet connection as claimed in claim 1, wherein the at least one material-removing tool is arranged rotatably with respect to the pin on at least one bearing.

12. The device for releasing a rivet connection as claimed in claim 1, wherein the at least one material-removing tool has at least one bushing for receiving the pin.

13. The device for releasing a rivet connection as claimed in claim 1, wherein the pin has a self-cutting thread at the lower end.

14. The device for releasing a rivet connection as claimed in claim 1, wherein the at least one material-removing tool and the pin can at least partially be moved freely axially with respect to each other.

15. The device for releasing a rivet connection as claimed in claim 1, wherein the pin is secured with respect to the at least one material-removing tool at least in one axial direction.

16. The device for releasing a rivet connection as claimed in claim 4, wherein the at least one material-removing tool can be clamped into a drilling machine by the holding arbor.

17. The device for releasing a rivet connection as claimed in claim 1, wherein the pin has a diameter of between 1.5 and 15 mm.

18. The device for releasing a rivet connection as claimed in claim 1, wherein the at least one material-removing tool has a diameter that is 1.5 to 6 mm larger than a diameter of the pin.

19. The device for releasing a rivet connection as claimed in claim 4, wherein the holding arbor and the pin are clamped in an axial direction by at least one spring.

20. The device for releasing a rivet connection as claimed in claim 19, wherein the holding arbor and the pin are secured together by a securing pin or a securing ring.

21. The device for releasing a rivet connection as claimed in claim 20, wherein the holding arbor has at least one groove in which the securing pin or securing ring can be latched.

22. The device for releasing a rivet connection as claimed in claim 3, wherein the castellated milling cutter comprises beveled faces so that chips can be removed in an upward direction.

23. The device for releasing a rivet connection as claimed in claim 3, wherein the castellated milling cutter comprises faces that run, at least in some sections, at an angle of 0.1° to 30° with respect to an axis of rotation of the castellated milling cutter.

24. The device for releasing a rivet connection as sclaimed in claim 3, wherein the castellated milling cutter comprises faces that run, at least in some sections, at an angle of 0.5° to 15° with respect to an axis of rotation of the castellated milling cutter.

25. The device for releasing a rivet connection as claimed in claim 3, wherein the castellated milling cutter has a rake angle of 0.1° to 30°.

26. The device for releasing a rivet connection as claimed in claim 3, wherein the castellated milling cutter has a rake angle of 0.5° to 15°.

27. The device for releasing a rivet connection as claimed in claim 3, wherein the castellated milling cutter comprises cutting edges that are relief-ground into at least two steps.

28. The device for releasing a rivet connection as claimed in claim 27, wherein the at least two steps comprises a first step having a clearance angle of 5° to 30° and/or a second step having a clearance angle of 30° to 70°.

29. A method for removing a rivet nut or press-in nut connection having a threaded stem and a nut head, the method comprising:
screwing a pin by a thread into the nut head;
removing the nut head by rotating a material-removing tool about the threaded pin; and
using the pin to pull out the threaded stem remaining after removal of the nut head.

30. The method as claimed in claim 29, further comprising locking the pin and material-removing tool against rotation with respect to each other during the screwing-in of the pin.

31. The method as claimed in claim 30, further comprising releasing the pin and material-removing tool for rotation with respect to each other after the screwing-in of the pin.

32. The method as claimed in claim 31, further comprising pressing the material-removing tool and the pin are apart in the axial direction by after releasing the pin and material-removing tool.

33. The method as claimed in claim 29, wherein the material-removing tool comprises a castellated milling cutter.

34. The method as claimed in claim 29, further comprising applying an axial force to move the material-removing tool in the direction of the nut head.
